(19) United States
(12) Patent Application Publication
(10) Pub. No.: US 2007/0271242 A1
(43) Pub. Date: Nov. 22, 2007

(54) POINT-IN-TIME QUERY METHOD AND SYSTEM

(75) Inventor: Christopher Lindblad, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mark Logic Corporation, San Mateo, CA (US)

(21) Appl. No.: 11/750,966

(22) Filed: May 18, 2007

Related U.S. Application Data
(60) Provisional application No. 60/801,899, filed on May 19, 2006.

(51) Int. Cl. G06F 17/30

(52) U.S. Cl. 707/3

(57) ABSTRACT

Embodiments of the present invention include storing a plurality of subtrees in a database, the plurality of subtrees representing one or more structured documents. At least one subtree has a birth timestamp indicating a time at which the at least one subtree was created. If a subtree has been obsoleted, the subtree has a death timestamp indicating a time at which the subtree was obsoleted. Embodiments further include receiving a database query comprising a query string and a query timestamp, the query timestamp indicating a historical time for which the query is to apply, and determining an intermediate result list of subtrees. The intermediate result list is filtered to generate a final result list responsive to the database query, the filtering comprising removing subtrees that do not have a birth timestamp, have a birth timestamp later than the query timestamp, or have a death timestamp earlier than the query timestamp.

### CROSS-REFERENCES TO RELATED APPLICATIONS

This application claims the benefit of U.S. Provisional Application No. 60/801,899, filed May 19, 2006 by Lindblad and entitled “POINT-IN-TIME QUERY METHOD AND SYSTEM,” which disclosure is incorporated herein by reference for all purposes.

This application is related to the following commonly-owned, co-pending applications:

U.S. patent application Ser. No. 10/462,100 (Attorney Docket No. 021512-000110US, entitled “SUBTREE-STRUCTURED XML DATABASE,” hereinafter “Lindblad I-A”);

U.S. patent application Ser. No. 10/462,019 (Attorney Docket No. 021512-000210US, entitled “PARENT-CHILD QUERY INDEXING FOR XML DATABASES,” hereinafter “Lindblad TI-A”);

U.S. patent application Ser. No. 10/462,023 (Attorney Docket No. 021512-000310US, entitled “XML DB TRANSACTIONAL UPDATE SYSTEM,” hereinafter “Lindblad III-A”); and

U.S. patent application Ser. No. 10/461,935 (Attorney Docket No. 021512 000410US, entitled “XML DATABASE MIXED STRUCTURAL-TEXTUAL CLASSIFICATION SYSTEM,” hereinafter “Lindblad IV-A”).

### The respective disclosures of these applications are incorporated herein by reference for all purposes.

### BACKGROUND OF THE INVENTION

Embodiments of the present invention relate generally to databases, and more particularly to query operations performed on structured database systems.

Extensible Markup Language (“XML”) is a restricted form of SGML, the Standard Generalized Markup Language defined in ISO 8879, and represents one form of structuring data. XML is more fully described in “Extensible Markup Language (XML) 1.0 (Second Edition),” W3C Recommendation (6 Oct. 2000) (hereinafter “XML Recommendation”), which is incorporated herein by reference for all purposes [and available at http://www.w3.org/TR/2000/REC-xml-20001006]. XML is a useful form of structuring data because it is an open format that is human-readable and machine-interpretable. Other structured languages without these features or with similar features may be used instead of XML, but XML is currently a popular structured language used to encapsulate (e.g., obtain, store, process, etc.) data in a structured manner.

An XML document has two parts: 1) a markup document and 2) a document schema. The markup document and the schema are made up of storage units called “elements,” which may be nested to form a hierarchical structure. An example of an XML markup document 10 is shown in FIG. 1. Document 10 (at least the portions shown) contains data for one “citation” element. The “citation” element has within it a “title” element, an “author” element, and an “abstract” element. In turn, the “author” element has within it a “last” element (last name of the author) and a “first” element (first name of the author). Thus, an XML document comprises text organized in freely-structured outline form with tags indicating the beginning and end of each outline element. A tag is delimited with angle brackets surrounding the tag's name, with the opening and closing tags distinguished by having the closing tag beginning with a forward slash after the initial angle bracket.

Elements can contain either parsed or unparsed data. Only parsed data is shown for document 10. Unparsed data is made up of arbitrary character sequences. Parsed data is made up of characters, some of which form character data and some of which form markup. The markup encodes a description of the document's storage layout and logical structure. XML elements can have associated attributes, in the form of name-value pairs, such as the publication date attribute of the “citation” element. The name-value pairs appear within the angle brackets of an XML tag, following the tag name.

XML schemas specify constraints on the structures and types of elements and attribute values in an XML document. The basic schema for XML is the XML Schema, described in “XML Schema Part 1: Structures,” W3C Working Draft (24 Sep. 1999), which is incorporated herein by reference for all purposes [and available at http://www.w3.org/TR/1999/WD-xmlschema-1-19990924]. A previous and very widely used schema format is the Document Type Definition (“DTD”), which is described in the XML Recommendation.

Since XML documents are often in text format, they can be searched using conventional text search tools. However, such tools typically ignore the information content provided by the structure of the document, which is one of the key benefits of XML. Several query languages have been proposed for searching and reformatting XML documents that do consider their structured nature. One such language is XQuery, described in “XQuery 1.0: An XML Query Language,” W3C Working Draft (23 Jan. 2007), which is incorporated herein by reference for all purposes [and available at http://www.w3.org/TR/XQuery]. An exemplary form for an XQuery query is shown in FIG. 2. Note that the ellipses at line [03] indicate the possible presence of any number of additional namespace prefix to URI mappings, the ellipses at line [16] indicate the possible presence of any number of additional function definitions, and the ellipses at line [22] indicate the possible presence of any number of additional FOR or LET clauses.

XQuery is derived from an XML query language called Quilt [described at http://www.almaden.ibm.com/cs/people/chamberlin/quilt.html], which in turn borrowed features from several other languages, including XPath 1.0 [described at http://www.w3.org/TR/XPath.html], XQL [described at Http://www.w3.org/TandS/QL/QL98/pp/xql.html], XML-QL [described at http://www.research.att.com/˜mff/files/final.html] and OQL.

Query languages predate the development of XML and many relational databases use a standardized query language known as SQL, as described in ISO/IEC 9075-1:1999. The SQL language has established itself as the lingua franca for relational database management and provides the basis for systems interoperability, application portability, client/server operation, and distributed databases. XQuery is proposed to fulfill a similar same role with respect to XML database systems. As XML becomes the standard for information exchange between peer data stores and between client visualization tools and data servers, XQuery may become the standard method for storing and retrieving data from XML databases.

With SQL query systems, much work has been done on the issue of efficiency, such as how to process a query, retrieve matching data, and present that to a human or computer query issuer with efficient use of computing resources. As XQuery and other tools are increasingly relied on for querying XML documents, efficiency will become more essential.

As noted above, XML documents are generally text files. As larger and more complex data structures are implemented in XML, updating or accessing these text files becomes difficult. For example, modifying data can require reading the entire text file into memory, making the changes, and then writing back the text file to persistent storage. It would be desirable to provide a more efficient way of storing and managing XML document data to facilitate accessing and/or updating information.

Further, “point-in-time” queries are not efficiently handled by existing database systems. A point-in-time query allows a user to execute a query against a prior (i.e., historical) state of a database. For example, a user may wish to retrieve the results for a query as if it were executed yesterday, or last month. In current database implementations, a point-in-time query is typically executed by “rolling back” changes to the database using historical change logs to yield a version of the database at the point in time requested. Alternatively, a database system may start from a previous state of the database (e.g., a historical snapshot) and “roll forward” changes using the historical change logs to yield the requested database state. Unfortunately, both of these approaches for handling point-in-time queries are resource intensive, generally making point-in-time queries much slower than “current time” queries.

### BRIEF SUMMARY OF THE INVENTION

Embodiments of the present invention address the foregoing and other such problems by providing methods, systems, and machine-readable media for efficiently storing and querying structured data (e.g., XML documents) in a database. Specifically, various embodiments provide for the efficient processing of point-in-time queries.

As described in further detail below, structured documents (e.g., XML) may be organized and stored in a database as a plurality of subtrees. For example, each element in an XML document may correspond to a subtree node. Relationships between individual subtrees may be maintained by including a link node in each subtree, the link node storing a reference to one or more neighboring subtrees.

In one set of embodiments, the database may associate one or more timestamps with each subtree, thereby preserving past states of the database. For example, a subtree may have a “birth” timestamp indicating the time at which the subtree was created. A subtrees may also have a “death” timestamp indicating the time at which the subtree was marked for deletion, if applicable. Thus, subtrees are not immediately deleted from the database in a physical sense when a delete or update operation occurs; rather, they are merely marked as being obsolete as of the time of that operation (the death timestamp).

Using birth and death timestamps, point-in-time queries can be efficiently supported. As described above, a point-in-time query is a query that is meant to be run with respect to a historical state of a database (e.g., the database state as of yesterday, or last month). A point-in-time query typically includes a query string and a query timestamp, the query timestamp indicating a point in time that is earlier than the time at which the query is executed. By comparing the query timestamp with the birth and/or death timestamp of one or more subtrees, the query results for that point in time (corresponding to a historical database state) can be determined. For example, if a subtree has a birth timestamp that is later then the query timestamp, then the subtree was not yet in existence at the time of the query and therefore is excluded from the query results. Similarly, if a subtree has a death timestamp that is earlier than the query timestamp, the subtree was deleted before the time of the query and therefore is excluded from the query results.

In various embodiments, one or more indexes are used to provide mappings between terms in the query string and the plurality of subtrees in the database. The indexes may be independent of the birth and death timestamps. Thus, according to one embodiment, the indexes are used to retrieve an intermediate result list containing all of the subtrees responsive to the query string in a point-in-time query. The intermediate result list is then filtered by comparing the birth and/death timestamps of each subtree in the intermediate result list against the query timestamp to produce a final result list.

In various embodiments, a garbage collection mechanism may be run on a periodic basis on the database to reclaim space consumed by obsolete subtrees that are marked for deletion. Once these subtrees are physically deleted from the database by the garbage collection mechanism, they are no longer available to be queried using point-in-time queries. However, in various embodiments the aggressiveness of the garbage collection schedule can be controlled to manage how “far back” into the past point-in-time queries can be run.

Embodiments of the present invention are more efficient than current database systems in processing point-in-time queries because the historical states of the database are directly available from the set of subtrees stored on disk (via the birth and death timestamps). Thus, there is no need to “roll back” or “roll forward” changes to the database using historical journals or logs to recreate a past state of the database prior to querying. In various embodiments, point-in-time queries have the same time and resource cost as “current time” queries because current time queries are executed in the same manner (e.g., with a query timestamp equal to the current time). Further, although embodiments of the present invention may result in larger indexes (containing references to both deleted and current subtrees), the cost of these larger indexes is low since index traversal is not a linear process. Finally, in an archival setting, where data is being continually added and no data is deleted, the present model has pragmatically no incremental cost.

According to one aspect of the present invention, a method for processing database queries includes storing a plurality of subtrees in a database, where the plurality of subtrees represent one or more structured documents (e.g., XML documents). At least one subtree in the plurality of subtrees has a birth timestamp indicating a time at which the at least one subtree was created in the database. If a subtree in the plurality of subtrees has been obsoleted, the obsoleted subtree has a death timestamp indicating a time at which the subtree was obsoleted. The method further includes receiving a database query comprising a query string and a query timestamp, the query timestamp indicating a historical time for which the query is to apply, and determining an intermediate result list of subtrees responsive to the query string. The intermediate result list is then filtered to generate a final result list of subtrees responsive to the database query, the filtering comprising removing subtrees that do not have a birth timestamp, have a birth timestamp later than the query timestamp, or have a death timestamp earlier than the query timestamp.

According to another aspect of the present invention, a database system is disclosed. The database system includes a database configured to store a plurality of subtrees, where the plurality of subtrees represent one or more structured documents. At least one subtree in the plurality of subtrees has a birth timestamp indicating a time at which the at least one subtree was created in the database. If a subtree in the plurality of subtrees has been obsoleted, the obsoleted subtree has a death timestamp indicating a time at which the subtree was obsoleted. The system also includes a query engine configured to receive a database query comprising a query string and a query timestamp, the query timestamp indicating a historical time for which the query is to apply, and determine an intermediate result list of subtrees responsive to the query string. The query engine is further configured to filter the intermediate result list to generate a final result list of subtrees responsive to the database query, the filtering comprising removing subtrees that do not have a birth timestamp, have a birth timestamp later than the query timestamp, or have a death timestamp earlier than the query timestamp.

According to yet another embodiment of the present invention, a machine-readable medium for a computer system includes instructions which, when executed by a processing component, cause the processing component to process a database query by storing a plurality of subtrees in a database, the plurality of subtrees representing one or more structured documents. At least one subtree in the plurality of subtrees has a birth timestamp indicating a time at which the at least one subtree was created in the database. If a subtree in the plurality of subtrees has been obsoleted, the obsoleted subtree has a death timestamp indicating a time at which the subtree was obsoleted. The machine-readable medium also includes instructions for causing the processing component to receive a database query comprising a query string and a query timestamp, the query timestamp indicating a historical time for which the query is to apply, and determine an intermediate result list of subtrees responsive to the query string. Further instructions cause the processing component to filter the intermediate result list to generate a final result list of subtrees responsive to the database query, the filtering comprising removing subtrees that do not have a birth timestamp, have a birth timestamp later than the query timestamp, or have a death timestamp earlier than the query timestamp.

A further understanding of the nature and the advantages of the embodiments disclosed herein may be realized by reference to the remaining portions of the specification and the attached drawings.

### BRIEF DESCRIPTION OF THE DRAWINGS

Various embodiments in accordance with the present invention will be described with reference to the drawings, in which:

FIG. 1 illustrates a conventional XML document;

FIG. 2 illustrates an XQuery query;

FIG. 3 illustrates a simple XML document including text and markup;

FIG. 4 is a schematic representation of the XML document shown in FIG. 3; FIG. 4A illustrates a complete representation of the XML document and FIG. 4B illustrates a subtree of the XML document;

FIG. 5 is a more concise schematic representation of an XML document;

FIG. 6 illustrates a portion of an XML document that includes tags with attributes; FIG. 6A shows the portion in XML format; FIG. 6B is a schematic representation of that portion in graphical form;

FIG. 7 shows a more complex example of an XML document, having attributes and varying levels;

FIG. 8 is a schematic representation of the XML document shown in FIG. 7, omitting data nodes;

FIG. 9 illustrates one decomposition of the XML document illustrated in FIGS. 7-8;

FIG. 10 illustrates the decomposition of FIG. 9 with the addition of link nodes;

FIG. 11 is a detail of a link node structure from the decomposition illustrated in FIG. 10;

FIG. 12A is a block diagram representing elements of a subtree data structure according to an embodiment of the present invention;

FIG. 12B is a simplified block diagram of elements of a data structure for storing atom data according to an embodiment of the present invention;

FIG. 13 is a simplified block diagram of a database system according to an embodiment of the present invention;

FIG. 14 is a simplified block diagram of a parser for a database system according to an embodiment of the present invention;

FIG. 15 is a block diagram showing elements of a database according to an embodiment of the present invention;

FIG. 16 is a flow diagram of a method of marking new subtrees with a birth timestamp and deleted subtrees with a death timestamp according to an embodiment of the present invention; and

FIG. 17 is a flow diagram of a method of performing a point-in-time query according to an embodiment of the present invention.

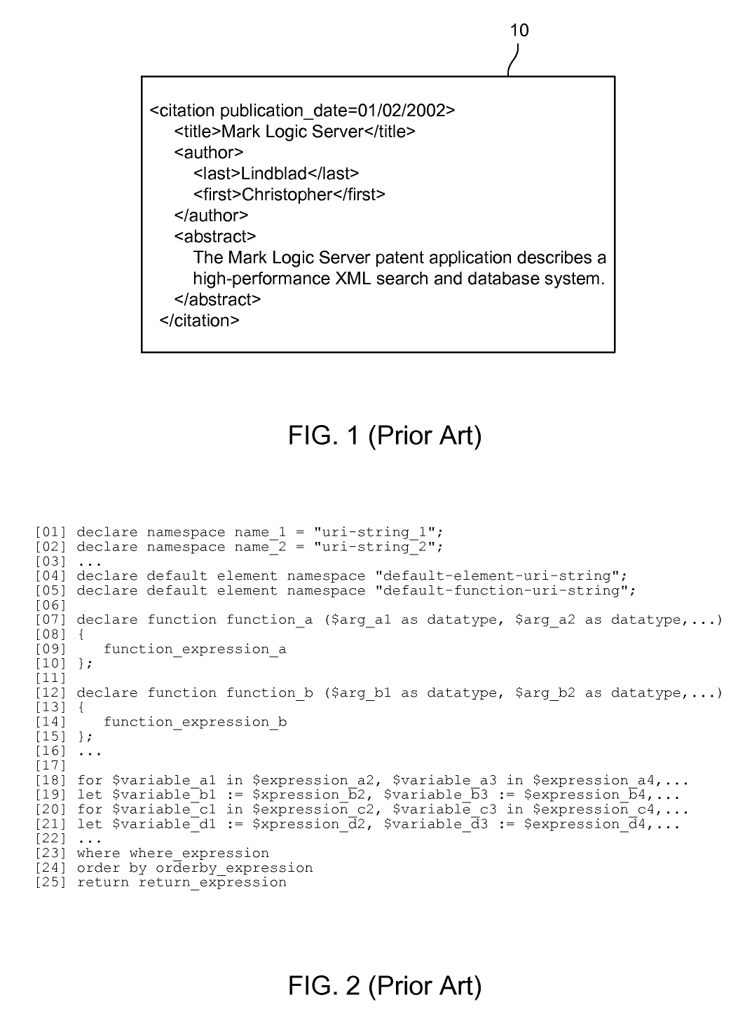

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention relate structured database systems, and specifically to processing point-in-time queries on such systems. In one embodiment, XML data is organized and stored as subtrees in a database. The subtrees are marked with a “birth timestamp” (similar to a “system change number”) at the time they are created and a “death timestamp” at the time they are marked for deletion. In one embodiment, multiple subtrees created by the same query may share the same birth timestamp. For both birth and death timestamps, their times may be synchronized to a clock time such as Greenwich meantime, or to an arbitrary time scale defined, for example, by a counter.

In various embodiments, a point-in-time query is processed by comparing a query timestamp with the birth and/or death timestamps of the subtrees. For example, according to one set of embodiments, the point-in-time query is not allowed to “see” subtrees that have a birth timestamp that is later than the query timestamp. This ensures that the query does not retrieve subtrees that did not exist in the database at the time of the query timestamp. Further, the query is not allowed to “see” subtrees that have a death timestamp earlier than the query timestamp. This ensures that the query does not retrieve subtrees that were marked for deletion at the time of the of the query timestamp.

Thus, in various embodiments, the birth timestamp prevents queries from accessing new subtrees before they are created (e.g., before an insert operation creating a subtree is transactionally complete), and the death timestamp prevents queries from accessing obsolete subtrees once they have been marked for deletion.

### Subtree Decomposition

In an embodiment of the present invention, an XML document (or other structured document) is parsed into “subtrees” for efficient handling. An example of an XML document and its decomposition is described in this section, with following sections describing apparatus, methods, structures and the like that might create and store subtrees. Subtree decomposition is explained with reference to a simple example, but it should be understood that such techniques are equally applicable to more complex examples.

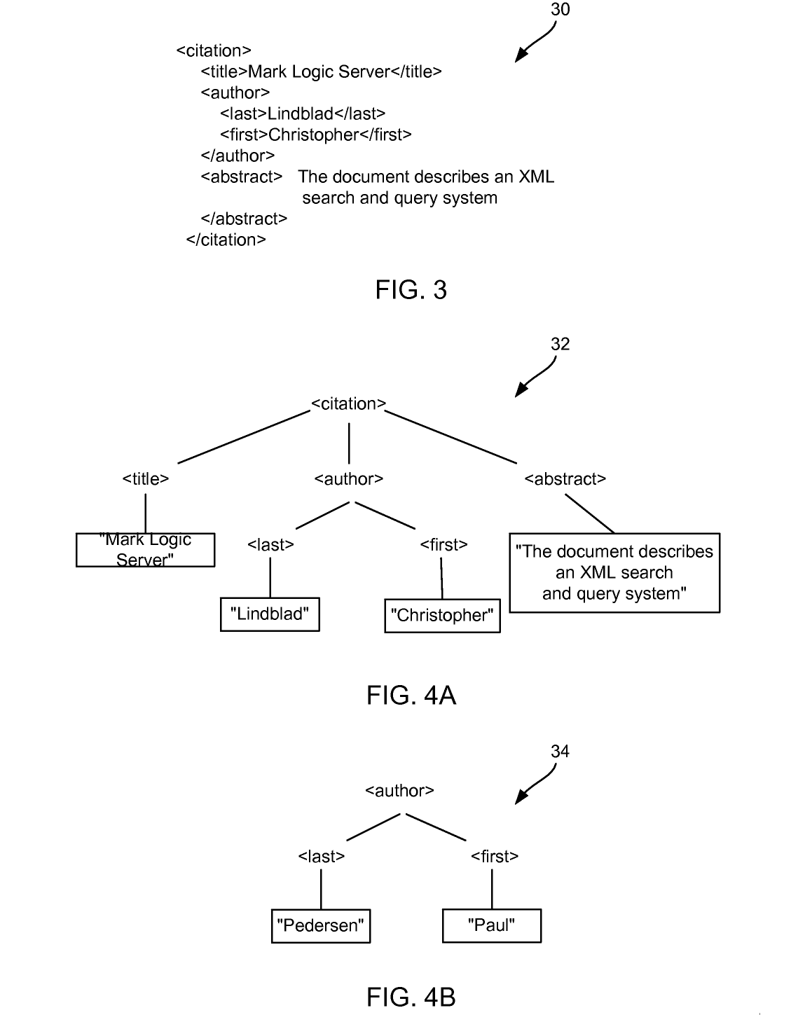

FIG. 3 illustrates an XML document 30, including text and markup. FIG. 4A illustrates a schematic representation 32 of XML document 30, wherein schematic representation 12 is a shown as a tree (a connected acyclic simple directed graph). with each node of the tree representing an element of the XML document or an element's content, attribute, the value, etc.

In a convention used for the figures of the present application, directed edges are oriented from an initial node that is higher on the page than the edge's terminal node, unless otherwise indicated. Nodes are represented by their labels, often with their delimiters. Thus, the root node in FIG. 4A is a “citation” node represented by the label delimited with “< >”. Data nodes are represented by rectangles. In many cases, the data node will be a text string, but other data node types are possible. In many XML files, it is possible to have a tag with no data (e.g., where a sequence such as “<tag></tag>” exists in the XML file). In such cases, the XML file can be represented as shown in FIG. 4A but with some nodes representing tags being leaf nodes in the tree. The present invention is not limited by such variations, so to focus explanations, the examples here assume that each “tag” node is a parent node to a data node (illustrated by a rectangle) and a tag that does not surround any data is illustrated as a tag node with an out edge leading to an empty rectangle. Alternatively, the trees could just have leaf nodes that are tag nodes, for tags that do not have any data.

As used herein, “subtree” refers to a set of nodes with a property that one of the nodes is a root node and all of the other nodes of the set can be reached by following edges in the orientation direction from the root node through zero or more non-root nodes to reach that other node. A subtree might contain one or more overlapping nodes that are also members of other “inner” or “lower” subtrees; nodes beyond a subtree's overlapping nodes are not generally considered to be part of that subtree. The tree of FIG. 4A could be a subtree, but the subtree of FIG. 4B is more illustrative in that it is a proper subset of the tree illustrated in FIG. 4A.

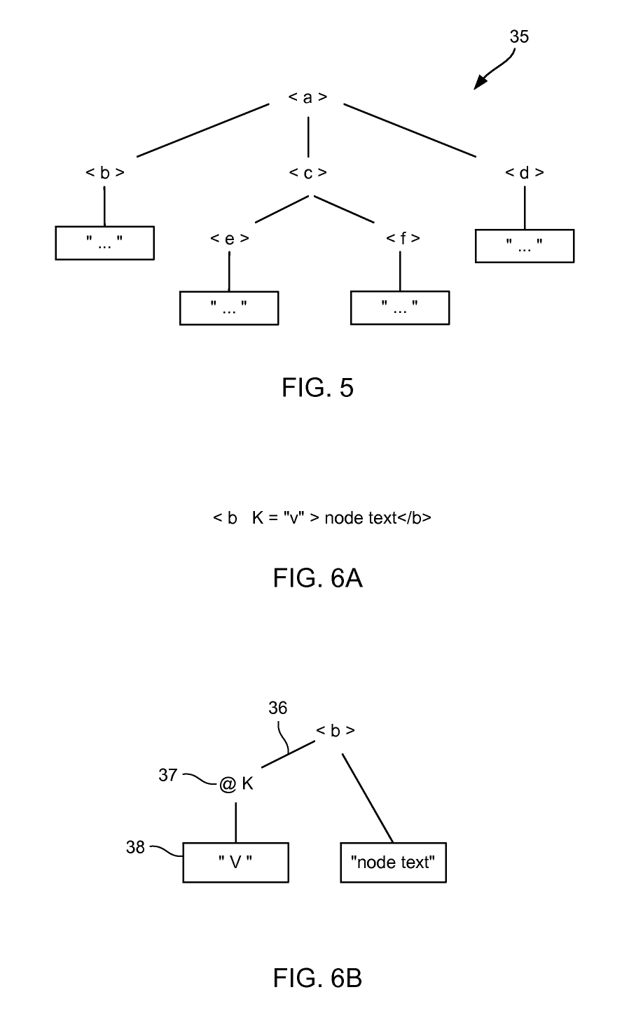

To simplify the following description and figures, single letter labels will be used, as in FIG. 5. Note that even with the shortened tags, tree 35 in FIG. 5 represents a document that has essentially the same structure as the document represented by the tree of FIG. 4A.

Some nodes may contain one or more attributes, which can be expressed as (name, value) pairs associated with nodes. In graph theory terms, the directed edges come in two flavors, one for a parent-child relationship between two tags or between a tag and its data node, and one for linking a tag with an attribute node representing an attribute of that tag. The latter is referred to herein as an “attribute edge”. Thus, adding an attribute (key, value) pair to an XML file would map to adding an attribute edge and an attribute node, followed by an attribute value node to a tree representing that XML file. A tag node can have more than one attribute edge (or zero attribute edges). Attribute nodes have exactly one descendant node, a value node, which is a leaf node and a data node, the value of which is the value from the attribute pair.

In the tree diagrams used herein, attribute edges sometimes are distinguished from other edges in that the attribute name is indicated with a preceding “@”. FIG. 6A illustrates a portion of XML markup wherein a tag T has an attribute name of “K” and a value of “V”. FIG. 6B illustrates a portion of a tree that is used to represent the XML markup shown in FIG. 6A, including an attribute edge 36, an attribute node 37 and a value node 38. In some instances, tag nodes and attribute nodes are treated the same, but at other times they are treated differently. To easily distinguish tag nodes and attribute nodes in the illustrated trees, tag nodes are delimited with surrounding angle brackets (“< >”), while attribute nodes are delimited with an initial “@”.

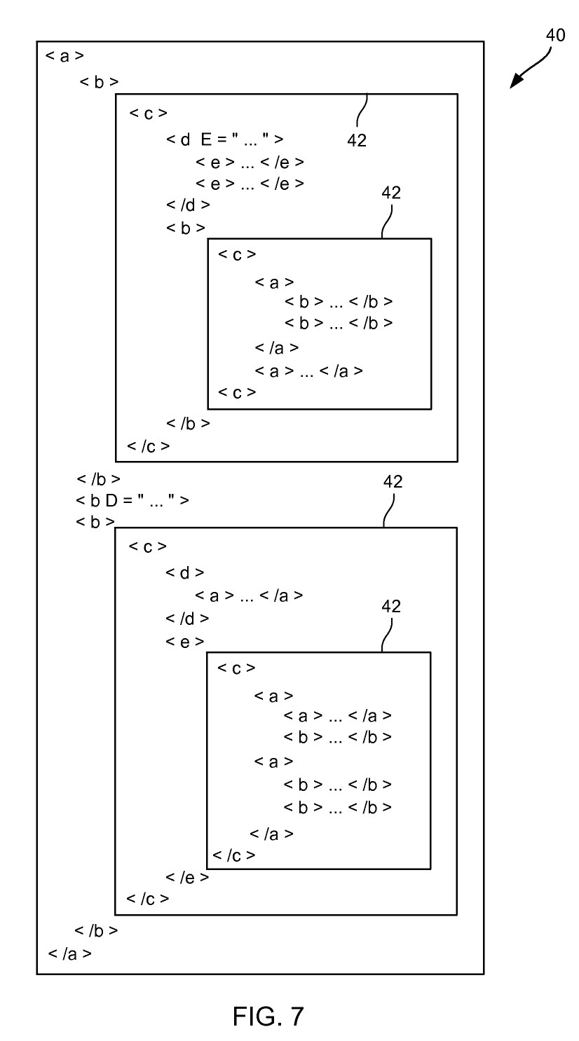

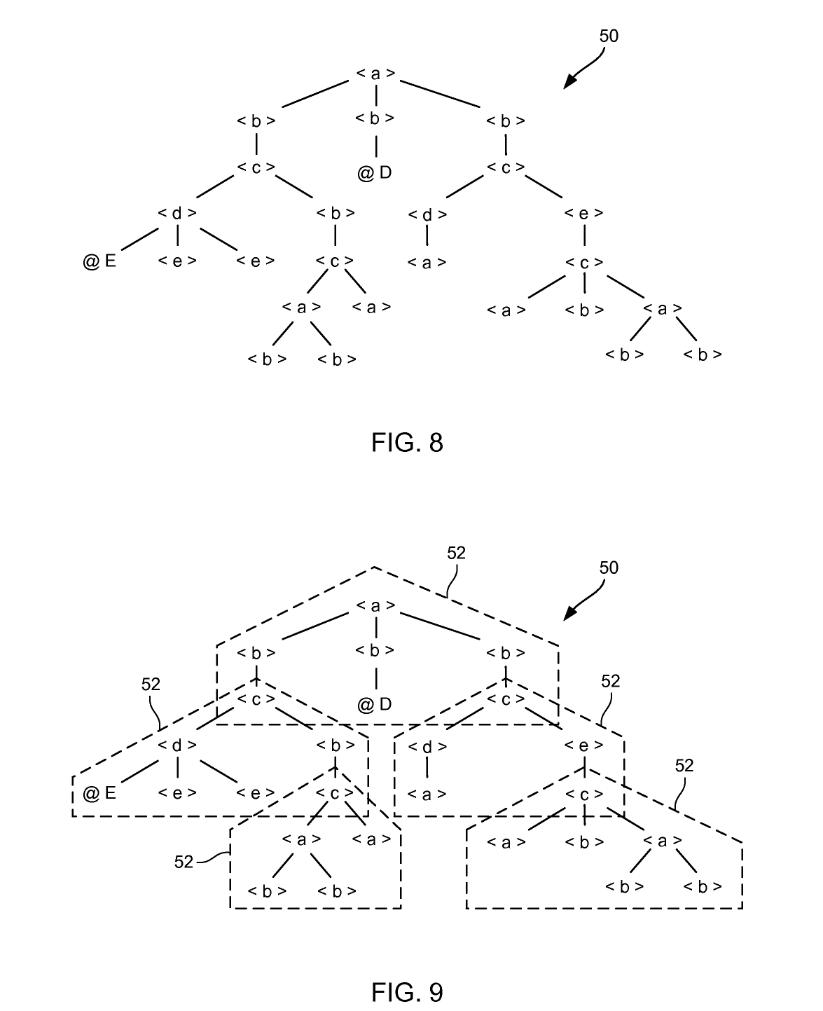

FIG. 7 et seq. illustrate a more complex example, with multiple levels of tags, some having attributes. FIG. 7 shows a multi-level XML document 40. As is explained later below, FIG. 7 also includes indications 42 of where multi-level XML document 40 might be decomposed into smaller portions. FIG. 8 illustrates a tree 50 that schematically represents multi-level XML document 40 (with a data nodes omitted).

FIG. 9 shows one decomposition of tree 50 with subtree borders 52 that correspond to indications 42. Each subtree border 52 defines a subtree; each subtree has a subtree root node and zero or more descendant nodes, and some of the descendant nodes might in turn be subtree root nodes for lower subtrees. In this example, the decomposition points are entirely determined by tag labels (e.g., each tag with a label “c” becomes a root node for a separate subtree, with the original tree root node being the root node of a subtree extending down to the first instances of tags having tag labels “c”). In other examples, decomposition might be done using a different set of rules. For example, the decomposition rules might be to break at either a “c” tag or an “f” tag, break at a “d” tag when preceded by an “r” tag, etc. Decomposition rules need not be specific to tag names, but can specify breaks upon occurrence of other conditions, such as reaching a certain size of subtree or subtree content. Some decomposition rules might be parameterized where parameters are supplied by users and/or administrators (e.g., “break whenever a tag is encountered that matches a label the user specifies”, or more generally, when a user-specified regular expression or other condition occurs).

Note from FIG. 9 that subtrees overlap. In a subtree decomposition process, such as one prior to storing subtrees in a database or processing subtrees, it is often useful to have nonoverlapping subtree borders. Assume that two subtrees overlap as they both include a common node (specifically, the subtree root node). The subtree that contains the common node and parent(s) of the common node is referred to herein as the upper overlapping subtree, while the subtree that contains the common node and child(ren) of the common node is referred to herein as the lower overlapping subtree.

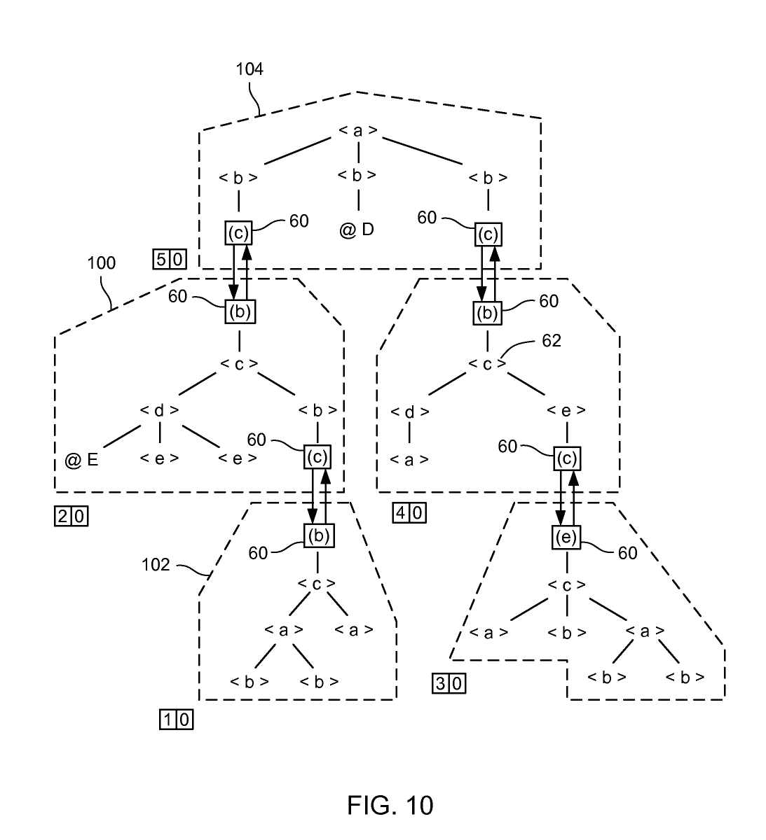

FIG. 10 illustrates one approach to providing nonoverlapping subtrees, namely by introducing the construct of link nodes 60. For each common node, an upper link node is added to the upper subtree and a lower link node is added to the lower subtree. These link nodes are shown in the figures by squares. The upper link node contains a pointer to the lower link node, which in turn contains a pointer to the root node of the lower overlapping subtree (which was the common node), while the lower link node contains a pointer to the upper link node, which in turn contains a pointer to the parent node of what was the common node. Each link node might also hold a copy of the other link node's label possibly along with other information. Thus, the upper link node may hold a copy of the lower subtree's root node label and the lower link node may hold a copy of the upper subtree's node label for the parent of what was the common node.

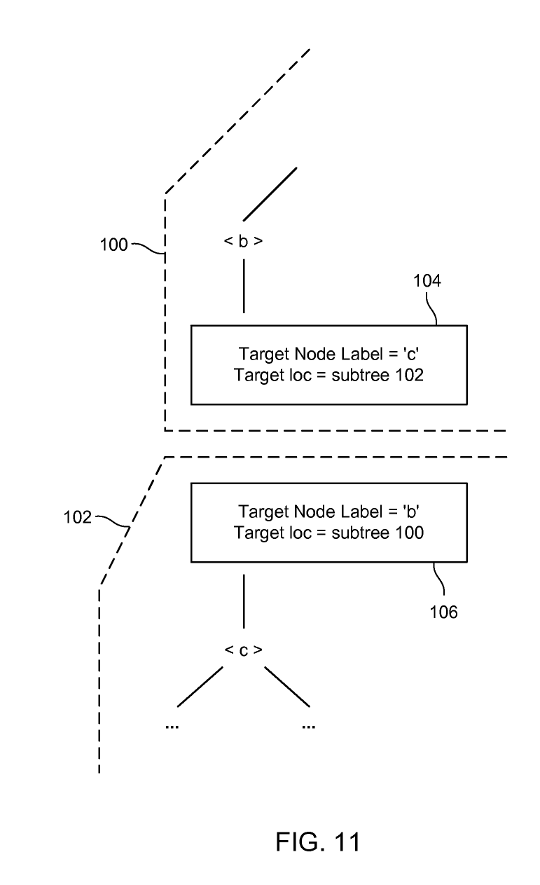

The pointer in a link node advantageously does not reference the other link node specifically; instead the pointer advantageously references the subtree in which the other link node can be found. FIG. 11 illustrates contents of the link nodes for two of the subtrees (labeled 101 and 102) of FIG. 10. Upper link node 104 of subtree 100 contains a target node label (‘c’) and a pointer to a target location that stores an identifier of subtree 102, which does not precisely identify lower link node 106. Similarly, lower link node 106 contains a target node label (‘b’) and a pointer to a target location that stores an identifier of subtree 100, which does not precisely identify upper link node 104.

Navigation from lower link node 106 to upper link node 104 (and vice versa) is nevertheless possible. For instance, the target location of lower link node 106 can be used to obtain a data structure for subtree 100 (an example of such a data structure is described below). The data structure for subtree 100 includes all seven of the nodes shown for subtree 100 in FIG. 10. Two of these are link nodes (labeled 60 in FIG. 10) that contain the target node label ‘c.’ These nodes, however, are distinguishable because their target location pointers point to different subtrees. Thus, the correct target node 104 for lower link node 106 can be identified by searching for a link node in subtree 100 whose target location is subtree 102. Similarly, the correct target node 106 for upper link node 104 can also be found by a search in subtree 102, enabling navigation in the other direction. Searching can be made highly efficient, e.g., by providing a hash table in subtree 100 that accepts a subtree identifier (e.g., for subtree 102) and returns the location of the link node that references that subtree.

Using a reference scheme that connects a link node to a target subtree (rather than to a particular node within the target subtree) makes lower link node 106 insensitive to changes in subtree 100. For instance, a new node may be added to subtree 100, causing the storage location of upper link node 104 to change. Lower link node 106 need not be modified; it can still reference subtree 100 and be able to locate upper link node 104. Likewise, upper link node 104 is insensitive to changes in subtree 102 that might affect the location of lower link node 106. This increases the modularity of the subtree structure. Subtree 100 can be modified without affecting link node 106 as long as link node 104 is not deleted. (If link node 104 is deleted, then subtree 102 is likely to be deleted as well.) Similarly, subtree 102 can be modified without affecting link node 104; if subtree 102 is deleted, then link node 104 will likely be deleted as well. Handling subtree updates that affect other subtrees is described in detail in Lindblad IIIA.

It should be noted that this indirect indexing approach is reliable as long as cyclic connections between subtrees are not allowed, i.e., as long as subtree 100 has only one node that connects to subtree 102 and vice versa. Those of ordinary skill in the art will appreciate that non-circularity is an inherent feature of XML and numerous other structured document formats.

### Subtree Data Structure

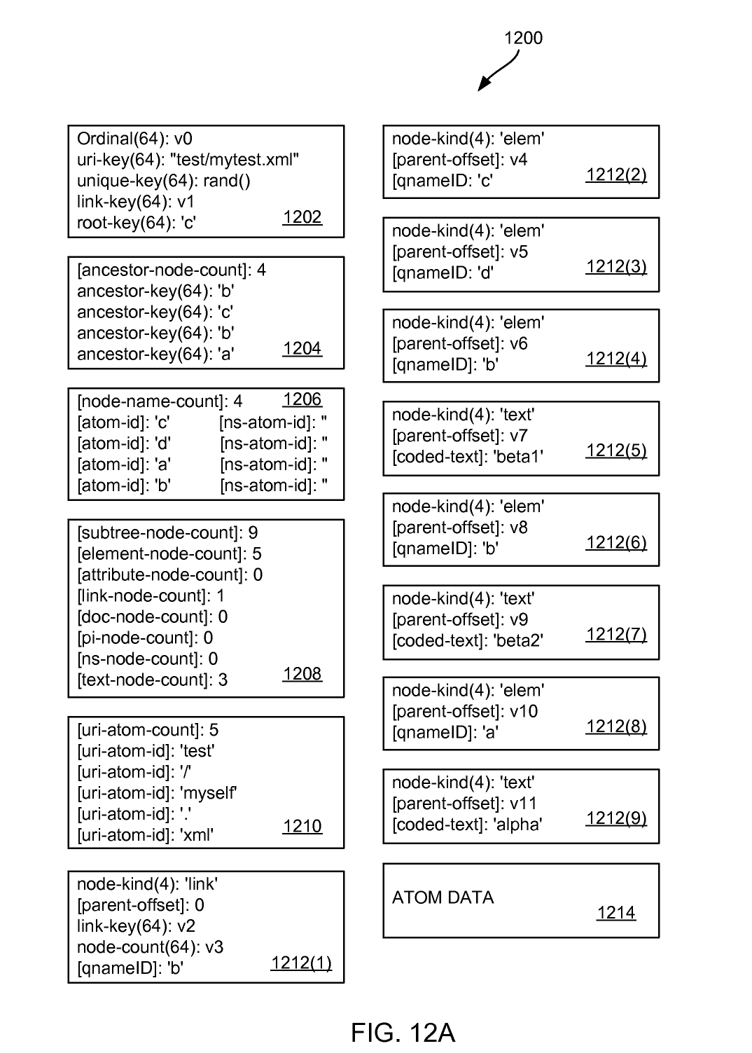

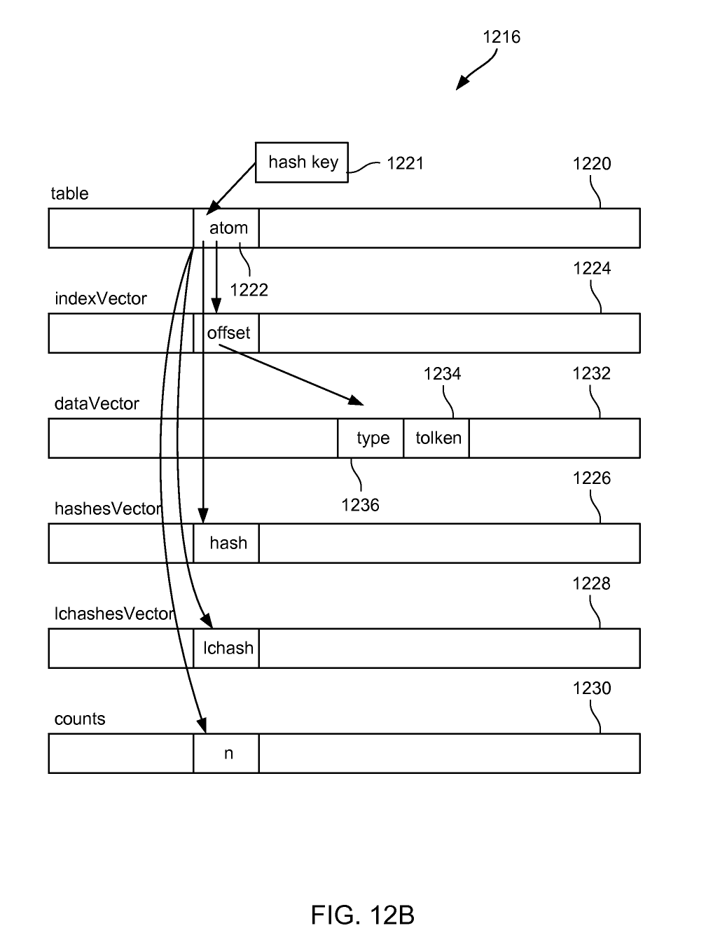

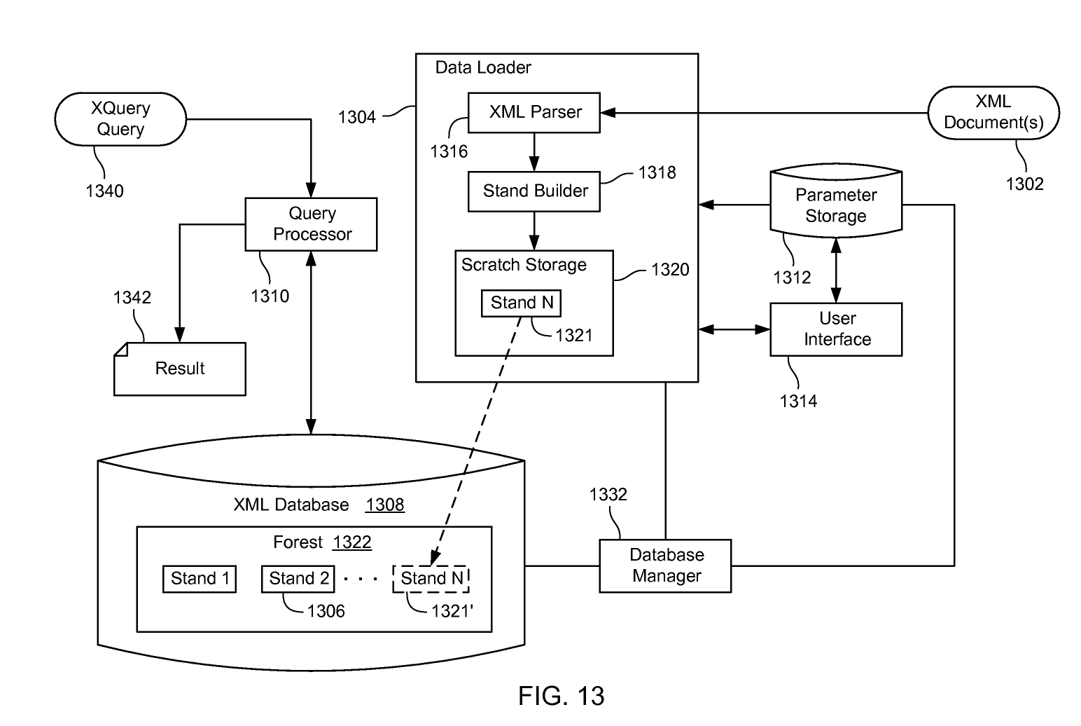

Each subtree can be stored as a data structure in a storage area (e.g., in memory or on disk), preferably in a contiguous region of the storage area. FIG. 12A illustrates an example of a data structure 1200 for storing subtree 102 of FIG. 10. In general, any subtree can be stored using a data structure similar to that of FIG. 12A.

In FIG. 12A, the following notational conventions are used: field(0:n-1): v describes a fixed-width N-bit field named ‘field’ and storing a value corresponding to ‘v’ (which might be an encoded version of v; examples are described below), and [field] describes a variable bit width field encoded using a unary-log-log encoding. The unary-log-log encoding represents an integer value N as follows: (a) compute the number of bits=log₂ (N) needed to represent the integer N; (b) compute the number of bits=log₂ (log₂ (N)) needed to represent log₂ (N); (c) encode the integer as log₂ (log₂ (N)) in unary, i.e., a sequence of log₂ (log₂ (N)) bits all equal to 1 terminated by 0 (or similar coding), followed by the bits needed to actually represent log₂ (N), followed by the bits actually needed to represent N. Text data values are generally stored in a format referred to herein as “CodedText,” in which the text string is parsed into one or more tokens and encoded as “[length], [atomID1], [atomID2], [atomID3], . . . ,” where the length is the unary-encoded length of the list of atomIDs, and each atomID is a code that corresponds to one of the tokens. Associations of atomIDs with specific tokens are provided by an atom data block 1214, which is shown in detail in FIG. 12B and described further below.

As shown in FIG. 12A, the subtree data is organized into various blocks. Header block 1202 contains identifying information for the subtree. Ancestry block 1204 provides information about the ancestor nodes of the subtree, tracing back to the ultimate parent node of the XML document. As FIG. 10 shows, subtree 102 has four ancestor nodes (not counting the link nodes): the parent of the subtree root node <c> is node <b> in subtree 102, whose parent is node <c>, whose parent is node <b> in subtree 104, whose parent is the ultimate root node <a>. Node name block 1206 provides the tags (encoded as atomIDs) for the element nodes in subtree 102. Subtree size block 1208 indicates the number of various kinds of nodes in subtree 102. URI information block 1210 provides (using atomIDs) the URI of the XML document to which subtree 102 belongs. The remaining node blocks 1212(1)-1212(9) provide information about each node of the subtree: the type of node, a reference to the node's parent, and other parameters appropriate for the node type. It is to be understood that the number of node blocks may vary, depending on the number of given nodes in the subtree. More specific information about the various elements of subtree data structure 1200 is listed in Table 1 and data types for representative types of nodes are listed in Table 2.

TABLE 1
Subtree Elements

| Block | Item | Description |
|---|---|---|
| Header | ordinal | Sequentially allocated node count for first node |
| | | in subtree |
| | uri-key | Hash value of URI of the document containing |
| | | the subtree |
| | unique-key | Random 64-bit key |
| | link-key | Random 64-bit key that is constant across saves. |
| | root-key | Hash subtree checksum |
| | [ancestor-node-count] | Coded count of number of ancestors (can be an |
| | | estimate) |
| | ancestor-key | Hash key of each ancestor subtree (repeated for |
| | | each ancestor) |
| Ancestry | [node-name-count] | Coded number of QNames (a QName might be a |
| | | namespace URI and a local name) element tags |
| | | in the subtree |
| | [atomID] | Coded Atom ID of element QName (repeated |
| | | for each element tag) |
| Node | [nsURI-atomID] | Coded Atom ID of element QName associated |
| name | | namespace (repeated for each element tag) |
| | [subtree-node-count] | Coded total number of nodes of all types in the |
| | | subtree |
| | [element-node-count] | Coded total number of element nodes in the |
| | | subtree |
| Subtree | [attribute-node-count] | Coded total number of attribute nodes in the |
| size | | subtree |
| | [link-node-count] | Coded total number of link nodes in the subtree |
| | [doc-node-count] | Coded total number of doc nodes in the subtree |
| | [pi-node-count] | Coded total number of processing instruction |
| | | nodes in the subtree |
| | [namespace-node-count] | Coded total number of namespace nodes in the |
| | | subtree |
| | [text-node-count] | Coded total number of text nodes in the subtree |
| | [uri-atom-count] | Coded count of tokens in the document URI |
| | [uri-atom-id] | Coded Atom ID(s) of each token of the |
| | | document URI |
| URI info | node-kind | See Table 2; one of: elem, attr, text, link, doc, |
| | | PI, ns, comment, etc. |
| | [parent-offset] | Coded implicitly negative offset (base 1) to |
| | | parent |
| Node | data element(s) | The content of the data element(s) depends on |
| | | the kind of node (specified by the node-kind |
| | | field). Table 2 lists some data element types that |
| | | might be used. This can comprise textual |
| | | representation of the data as a compressed list of |
| | | Atom IDs of the content of the element. |

TABLE 2
Data Element Types for Subtree Nodes

| Node Type | Data Field | Description |
|---|---|---|
| elem | [qnameID] | Coded element QName Atom ID |
| attr | [qnameID] | Coded attribute QName Atom ID |
| | CodedText | Coded text representing the attribute's value |
| text | CodedText | Coded text representing the text node value |
| PI | [PI-target-atomID] | Processing Instruction (typically opaque to the XQE |
| | | XML database) |
| | CodedText | Coded Atom ID of PI target |
| | CodedText | Coded text of PI |
| link | link-key | Link to parent/child subtree; bi-directional |
| | [qnameID] | Coded QName Atom ID of link-key target |
| | [node-count] | Coded initial ordinal for subtree nodes [?????] |
| comment | CodedText | Coded text of comment |
| docnode | CodedText | Coded text of docnode uri |
| ns | [delta-ordinal] | Coded ordinal of element containing the ns decl, delta |
| | | from last ns-decl |
| | [offset] | Coded offset in namespace list of preceding |
| | | namespace node |
| | [prefix-atomID] | Coded Atom ID of namespace prefix |
| | [nsURI-atomID] | Coded Atom ID of namespace URI |

It should be noted that each link node (such as described above with reference to FIG. 11) has a corresponding node block in the subtree data structure 1200; e.g., node block 1212(1) describes a link node, as indicated by the node-kind (‘link’). For the link node, the stored data includes a link-key element, a qname element, and a number-of-nodes element. The link-key element provides the reference to the subtree that contains the target node; for instance, value (v2) stored in the link key of node block 1212(1) may correspond to the link-key element that is stored in a lead block 1212 of a different subtree data structure that contains the target node. As noted in Table 1, the link-key element is defined so as to be constant across saves, making it a reliable identifier of the target subtree. Other identifiers could also be used. The qnameID element of node block 1212(1) stores (as an atomID) the QName of the target of the link identified by the link-key element. The QName might be just the tag label or a qualified version thereof (e.g., with a namespace URI prepended).

In the case where link node block 1212(1) corresponds to link node 106 of FIG. 11, the link-key value v2 identifies a data structure for subtree 100, and the qnameID corresponds to ‘b’. The node-count encodes an initial ordinal for the subtree nodes. Similar node blocks can be provided for nodes that link to child subtrees. In this manner, the connections between subtrees are reflected in the data structure.

As shown in FIG. 12A and Table 1, every node, regardless of its node-kind, includes a parent-offset element. This element represents the relationship between nodes in a unidirectional manner by providing, for each node, a way of identifying which node is its parent. For example, the value of a parent-offset element might be a byte offset reflecting the location of the parent node block within the data structure relative to the current node block. For link nodes whose parents are not in the subtree, a value of 0 can be used, as in block 1212(1). In the case of XML input documents, the byte offset can be implicitly negative as long as nodes appear in the data structure in the order they occur in the document, because the parent node will always precede the child. In other document formats or subtree data structures, parents might occur after the child and positive offsets would be allowed. In general, the node blocks may be placed in any order within data structure 1200, as long as the parent-offset values correctly reflect the hierarchical relationship of the nodes.

Atom data block 1214 is shown in detail in FIG. 12B. In this embodiment, atom data block 1214 implements a token heap, i.e., a system for compactly storing large numbers of tokens. A given token is hashed to produce a hash key 1221 that is used as an index into a “table” array 1220, which is a fixed-width array. The atom value 1222 stored in the table array at the hash key index position represents a cursor (or offset) into four other arrays: indexVector 1224, hashesVector 1226, lchashesVector 1228, and counts 1230. The offset stored at the atom index position in the (fixed-width) indexVector array 1224 represents an offset into the (variable-width) dataVector array 1232 where the actual token 1234 is stored along with one 8-bit byte of type information 1236; additional bits may also be provided for other uses. In this embodiment, the type of a token can be one of ‘s’ (space character), ‘p’ (punctuation character), or ‘w’ (word character); other types may also be supported. The atom value 1222 also indexes into the (fixed-width) hashesVector array 1228 and the (fixed-width) lcHashesVector array 1230. These two vector arrays are used as caches for token hash keys, and lower-cased token hash keys, and are provided to facilitate indexing and/or search operations. The atom value 1222 also indexes into the counts array 1230, where token multiplicities are stored, that is to say, each token is stored uniquely (i.e., once per subtree) in the dataVector array 1232, but the count describing the number of times the token appeared in the subtree is stored in the counts array 1230. This avoids the necessity of having to access multiple subtrees to count occurrences every time such information is needed.

It will be appreciated that the data structure described herein for storing subtree data is illustrative and that variations and modifications are possible. Different fields and/or field names may be used, and not all of the data shown herein is required. The particular coding schemes (e.g., unary coding, atom coding) described herein need not be used; different coding schemes or unencoded data may be stored. The arrangement of data into blocks may also be modified without restriction, provided that it is possible to determine which nodes are associated with a particular subtree and to navigate hierarchically between subtrees. Further, as described below, subtree data can be found in scratch space, in memory and on disk, and implementation details of the subtree data structure, including the atom data substructure, may vary within the same embodiment, depending on whether an in-scratch, in-memory, or on-disk subtree is being provided.

### Database Management System

### System Overview

According to one embodiment of the invention, a computer database management system is provided that parses XML documents into subtree data structures (e.g., similar to the data structure described above), and updates the subtree data structures as document data is updated. The subtree data structures may also be used to respond to queries.

A typical XML handling system according to one embodiment of the present invention is illustrated in FIG. 13. As shown there, system 1300 processes XML (or other structured) documents 1302, which are typically input into the system as files, streams, references or other input or file transport mechanisms, using a data loader 1304. Data loader 1304 processes the XML documents to generate elements (referred to herein as “stands”) 1306 for an XML database 1308 according to aspects of the present invention. System 1300 also includes a query processor (e.g., a query engine) 1310 that accepts queries 1340 against structured documents, such as XQuery queries, and applies them against XML database 1308 to derive query results 1342.

System 1300 also includes parameter storage 1312 that maintains parameters usable to control operation of elements of system 1300 as described below. Parameter storage 1312 can include permanent memory and/or changeable memory; it can also be configured to gather parameters via calls to remote data structures. A user interface 1314 might also be provided so that a human or machine user can access and/or modify parameters stored in parameter storage 1312.

Data loader 1304 includes an XML parser 1316, a stand builder 1318, a scratch storage unit 1320, and interfaces as shown. Scratch storage 1320 is used to hold a “scratch” stand 1321 (also referred to as an “in-scratch stand”) while it is in the process of being built by stand builder 1318. Building of a stand is described below. After scratch stand 1321 is completed (e.g., when scratch storage 1320 is full), it is transferred to database 1308, where it becomes stand 1321′.

System 1300 might comprise dedicated hardware such as a personal computer, a workstation, a server, a mainframe, or similar hardware, or might be implemented in software running on a general purpose computer, either alone or in conjunction with other related or unrelated processes, or some combination thereof. In one example described herein, database 1308 is stored as part of a storage subsystem designed to handle a high level of traffic in documents, queries and retrievals. System 1300 might also include a database manager 1332 to manage database 1308 according to parameters available in parameter storage 1312.

System 1300 reads and stores XML schema data type definitions and maintains a mapping from document elements to their declared types at various points in the processing. System 1300 can also read, parse and print the results of XML XQuery expressions evaluated across the XML database and XML schema store.

### Forests, Stands, and Subtrees

In the architecture described herein, XML database 1308 includes one or more “forests” 1322, where a forest is a data structure against which a query is made. In one embodiment, a forest 1322 encompasses the data of one or more XML input documents. Forest 1322 is a collection of one or more “stands” 1306, wherein each stand is a collection of one or more subtrees (as described above) that is treated as a unit of the database. The contents of a stand in one embodiment are described below. In some embodiments, physical delimitations (e.g., delimiter data) are present to delimit subtrees, stands and forests, while in other embodiments, the delimitations are only logical, such as by having a table of memory addresses and forest/stand/subtree identifiers, and in yet other embodiments, a combination of those approaches might be used.

In one implementation, a forest 1322 contains some number of stands 1306, and all but one of these stands resides in a persistent on-disk data store (shown as database 1308) as compressed read-only data structures. The last stand is an “in-memory” stand (not shown) that is used to re-present subtrees from on-disk stands to system 1300 when appropriate (e.g., during query processing or subtree updates). System 1300 continues to add subtrees to the in-memory stand as long as it remains less than a certain (tunable) size. Once the size limit is reached, system 1300 automatically flushes the in-memory stand out to disk as a new persistent (“on-disk”) stand.

### Data Flow

Two main data flows into database 1308 are shown. The flow on the right shows XML documents 1302 streaming into the system through a pipeline comprising an XML parser 1316 and a stand builder 1318. These components identify and act upon each subtree as it appears in the input document stream, as described below. The pipeline generates scratch data structures (e.g., a stand 1320) until a size threshold is exceeded, at which point the system automatically flushes the in-memory data structures to disk as a new persistent on-disk stand 1306.

The flow on the left shows processing of queries. A query processor 1310 receives a query (e.g., XQuery query 1340), parses the query, optimizes it to minimize the amount of computation required to evaluate the query, and evaluates it by accessing database 1308. For instance, query processor 1310 advantageously applies a query to a forest 1322 by retrieving a stand 1306 from disk into memory, apply the query to the stand in memory, and aggregate results across the constituent stands of forest 1322; some implementations allow multiple stands to be processed in parallel. Results 1342 are returned to the user. One such query system could be the system described in Lindblad IIA.

Queries to query processor 1310 can come from human users, such as through an interactive query system, or from computer users, such as through a remote call instruction from a running computer program that uses the query results. In one embodiment, queries can be received and responded to using a hypertext transfer protocol (HTTP). It is to be understood that a wide variety of query processors can be used with the subtree-based database described herein. According to one set of embodiments, query processor 1310 is particularly adapted to efficiently process point-in-time queries described in greater detail below.

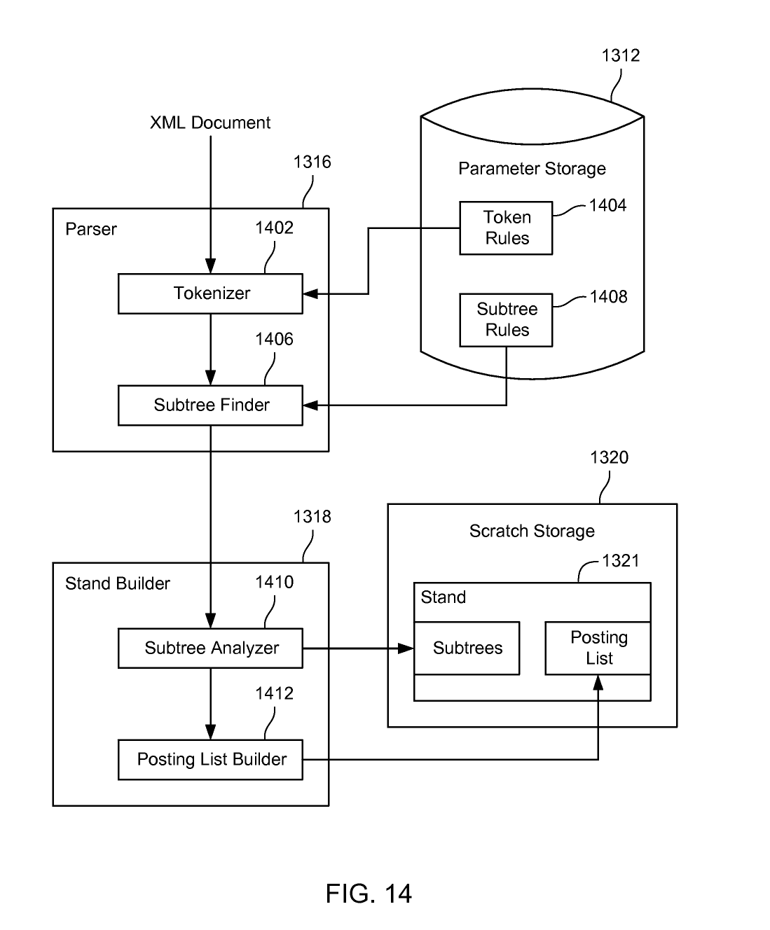

Processing of input documents will now be described. FIG. 14 shows parser 1316 and stand builder 1318 in more detail. As shown, parser 1316 includes a tokenizer 1402 that parses documents into tokens according to token rules stored in parameter storage 1312. As the input documents are normally text, or can normally be treated as text, they can be tokenized by tokenizer 1402 into tokens, or more generally into “atoms.” The text tokenizer identifies the beginning and ending of tokens according to tokenizing rules. Often, but not always, words (e.g., characters delimited by white space or punctuation) are identified as tokens. Thus, tokenizer 1402 might scan input documents and look for word breaks as defined by a set of configurable parameters included in token rules 1404. Preferably, tokenizer 1402 is configurable, handles Unicode inputs and is extensible to allow for language-specific tokenizers.

Parser 1316 also includes a subtree finder 1406 that allocates nodes identified in the tokenized document to subtrees according to subtree rules 1408 stored in parameter storage 1312. In one embodiment, subtree finder 1406 allocates nodes to subtrees based on a subtree root element indicated by the subtree rules 1408 Thus, an XML document is divided into subtrees from matching subtree nodes down. For example, if an XML document including citations was processed and the subtree root element was set to “citation”, the XML document would be divided into subtrees each having a root node of “citation”. In other cases, the division of subtrees is not strictly by elements, but can be by subtree size or tree depth constraints, or a combination thereof or other criteria.

Each subtree identified by subtree finder 1406 are provided to stand builder 1318, which includes a subtree analyzer 1410, a posting list generator 1412, and a key generator 1414. Subtree analyzer 1410 generates a subtree data structure (e.g., data structure 1200 of FIG. 12), which is added to the stand. Posting list generator 1412 generates data related to the occurrence of tokens in a subtree (e.g., parent-child index data as described in Lindblad IIA), which is also added to the stand. Stand builder 1318 may also include other data generation modules, such as a classification quality generator (not shown), that generate additional information on a per-subtree or per-stand basis and are stored as the stand is constructed. Classification quality information that might be included in system 1300 is described in Lindblad IV-A.

As stand builder 1318 generates the various data structures associated with subtrees, it places them into scratch stand 1320, which acts as a scratch storage unit for building a stand. The scratch storage unit is flushed to disk when it exceed a certain size threshold, which can be set by a database administrator (e.g., by setting a parameter in parameter storage 1312). In some implementations of data loader 1304, multiple parsers 1316 and/or stand builders 1318 are operated in parallel (e.g., as parallel processes or threads), but preferably each scratch storage unit is only accessible by one thread at a time.

### Stand Structure

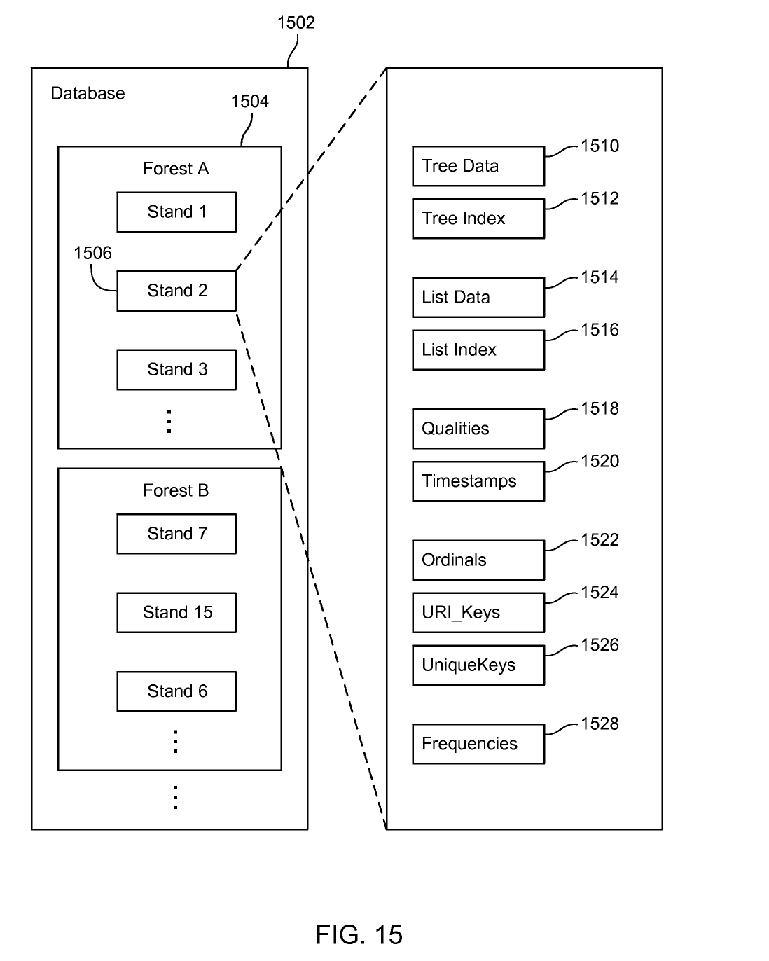

One example of a structure of an XML database used with the present invention is shown in FIG. 15. As illustrated there, database 1502 contains, among other components, one or more forest structures 1504.

Forest structure 1504 includes one or more stand structures 1506, each of which contains data related to a number of subtrees, as shown in detail for stand 1506. For example, stand 1506 may be a directory in a disk-based file system, and each of the blocks may be a file. Other implementations are also possible, and the description of “files” herein should be understood as illustrative and not limiting of the invention.

TreeData file 1510 includes the data structure (e.g., data structure 1200 of FIG. 12A) for each subtree in the stand. The subtree data structure may have variable length; to facilitate finding data for a particular subtree, a TreeIndex file 1512 is also provided. TreeIndex file 1512 provides a fixed-width array that, when provided with a subtree identifier, returns an offset within TreeData file 1510 corresponding to the beginning of the data structure for that subtree.

ListData file 1514 contains information about the text or other data contained in the subtrees that is useful in processing queries. For example, in one embodiment, ListData file 1514 stores “posting lists” of subtree identifiers for subtrees containing a particular term (e.g., an atom), and ListIndex file 1516 is used to provide more efficient access to particular terms in ListData file 1514. Examples of posting lists and their creation are described in detail in Lindblad IIA, and a detailed description is omitted herein as not being critical to understanding the present invention.

Qualities file 1518 provides a fixed-width array indexed by subtree identifier that encodes one or more numeric quality values for each subtree; these quality values can be used for classifying subtrees or XML documents. Numeric quality values are optional features that may be defined by a particular application. For example, if the subtree store contained Internet web pages as XHTML, with the subtree units specified as the <HTML> elements, then the qualities block could encode some combination of the semantic coherence and inbound hyper link density of each page. Further examples of quality values that could be implemented are described in Lindblad IVA, and a detailed description is omitted herein as not being critical to understanding the present invention.

Timestamps file 1520 provides a fixed-width array indexed by subtree identifier that stores two 64-bit timestamps indicating a creation and deletion time for the subtree. For subtrees that are current, the deletion timestamp may be set to a value (e.g., zero) indicating that the subtree is current. As described below, Timestamps file 1520 can be used to support modification of individual subtrees, as well as storing of archival information. Timestamps file 1520 may be filtered by query processor 1310 to enable historical database queries as described below.

The next three files provide selected information from the data structure 1200 for each subtree in a readily-accessible format. More specifically, Ordinals file 1522 provides a fixed-width array indexed by subtree identifier that stores the initial ordinal for each subtree, i.e., the ordinal value stored in block 1202 of the data structure 1200 for that subtree; because the ordinal increments as every node is processed, the ordinals for different subtrees reflects the ordering of the nodes within the original XML document. URI-Keys file 1524 provides a fixed-width array indexed by subtree identifier that stores the URI key for each subtree, i.e., the uri-key value stored in block 1202 of the data structure 1200. Unique-Keys file 1526 provides a fixed-width array indexed by subtree identifier that stores the unique key for each subtree, i.e., the unique-key value stored in block 1202 of the data structure 1200. It should be noted that any of the information in the Ordinals, URI-Keys, and Unique-Keys files could also be obtained, albeit less efficiently, by locating the subtree in the TreeData file 1510 and reading its subtree data structure 1200. Thus, these files are to be understood as auxiliary files for facilitating access to selected, frequently used information about the subtrees. Different files and different combinations of data could also be stored in this manner.

Frequencies file 1528 stores a number of entries related to the frequency of occurrence of selected tokens, which might include all of the tokens in any subtrees in the stand or a subset thereof. In one embodiment, for each selected token, frequency file 1528 holds a count of the number of subtrees in which the token occurs.

It will be appreciated that the stand structure described herein is illustrative and that variations and modifications are possible. Implementation as files in a directory is not required; a single structured file or other arrangement might also be used. The particular data described herein is not required, and any other data that can be maintained on a per-subtree basis may also be included. Use of subtree data structure 1200 is not required; as described above, different subtree data structures may also be implemented.

### Creation, Updating, and Deletion of Subtrees

As the stands of a forest are generated, processed and stored, they can be “log-structured”, i.e., each stand can be saved to a file system as a unit that is never edited (other than the timestamps file). To update a subtree, the old subtree is marked as deleted (e.g., by setting its deletion timestamp in Timestamps file 1520) and a new subtree is created. The new subtree with the updated information is constructed in a memory cache as part of an in-memory stand and eventually flushed to disk, so that in general, the new subtree may be in a different stand from the old subtree it replaces. Thus, any insertions, deletions and updates to the forest are processed by writing new or revised subtrees to a new stand. This feature localizes updates, rather than requiring entire documents to be replaced.

It should be noted that in some instances, updates to a subtree will also affect other subtrees; for instance, if a lower subtree is deleted, the link node in the upper subtree is preferably be removed, which would require modifying the upper subtree. Transactional updating procedures that might be implemented to handle such changes while maintaining consistency are described in detail in Lindblad IIIA.

It is to be understood that marking a subtree as deleted does not require that the subtree immediately be removed from the data store. Rather than removing any data, the current time can be entered as a deletion timestamp for the subtree in Timestamps file 1520 of FIG. 15. The subtree is treated as if it were no longer present for effective times after the deletion time. In some embodiments, subtrees marked as deleted may periodically be purged from the on-disk stands, e.g., during merging (described below).

### Merging of Stands

Stand size is advantageously controlled to provide efficient I/O, e.g., by keeping the TreeData file size of a stand close to the maximum amount of data that can be retrieved in a single I/O operation. As stands are updated, stand size may fluctuate. In some embodiments of the invention, merging of stands is provided to keep stand size optimized. For example, in system 1300 of FIG. 13, database manager 1332, or other process, might run a background thread that periodically selects some subset of the persistent stands and merges them together to create a single unified persistent stand.

In one embodiment, the background merge process can be tuned by two parameters: Merge-min-ratio and Merge-min-size, which can be provided by parameter storage 1312. Merge-min-ratio specifies the minimum allowed ratio between any two on-disk stands; once the ratio is exceeded, system 1300 automatically schedules stands for merging to reduce the maximum size ratio between any two on-disk stands. Merge-min-size limits the minimum size of any single on-disk stand. Stands below this size limit will be automatically scheduled for merging into some larger on-disk stand.

In the embodiment of a stand shown in FIG. 15, the merge process merges corresponding files between the two stands. For some files, merging may simply involve concatenating the contents of the files; for other files, contents may be modified as needed. As an example, two TreeData files can be merged by appending the contents of one file to the end of the other file. This generally will affect the offset values in the TreeIndex files, which are modified accordingly. Appropriate merging procedures for other files shown in FIG. 15 can be readily determined.

### System Parameters

As described above, parameters can be provided using parameter storage 1312 to control various aspects of system operation. Parameters that can be provided include rules for identifying tokens and subtrees, rules establishing minimum and/or maximum sizes for on-disk and in-memory stands, parameters for determining whether to merge on-disk stands, and so on.

In one embodiment, some or all of these parameters can be provided using a forest configuration file, which can be defined in accordance with a preestablished XML schema. For example, the forest configuration file can allow a user to designate one or more ‘subtree root’ element labels, with the effect that the data loader, when it encounters an element with a matching label, loads the portion of the document appearing at or below the matching element subdivision as a subtree. The configuration file might also allow for the definition of ‘subtree parent’ element names, with the effect that any elements which are found as immediate children of a subtree parent will be treated as the roots of contiguous subtrees.

More complex rules for identifying subtree root nodes may also be provided via parameter storage 1312, for example, conditional rules that identify subtree root nodes based on a sequence of element labels or tag names. Subtree identification rules need not be specific to tag names, but can specify breaks upon occurrence of other conditions, such as reaching a certain size of subtree or subtree content. Some decomposition rules might be parameterized where parameters are supplied by users and/or administrators (e.g., “break whenever a tag is encountered that matches a label the user specifies,” or more generally, when a user-specified regular expression or other condition occurs). In general, subtree decomposition rules are defined so as to optimize tradeoffs between storage space and processing time, but the particular set of optimum rules for a given implementation will generally depend on the structure, size, and content of the input document(s), as well as on parameters of the system on which the database is to be installed, such as memory limits, file system configurations, and the like.

### Point-In-Time Queries

### Timestamps

In various embodiments, each subtree may be associated with one or more timestamps indicating a change in state of the subtree. For example, a subtree may be associated with a “birth” timestamp indicating the time at which the subtree was created in the database. Further, a subtree may associated with a “death” timestamp indicating the time at which the subtree was marked for deletion (if applicable). As described above, subtrees are not immediately deleted from the database in a physical sense when an update or delete operation occurs; rather, they are merely rendered obsolete as of the date of that operation (e.g., the death timestamp). If a subtree has not yet been marked for deletion (i.e., is currently active), it may not have a death timestamp. Alternatively, the subtree may have a death timestamp with default value such as zero. In various embodiments, the death timestamp is later than or equal to the birth timestamp. The timestamp portion of the stand data structure is both readable and writable, thus allowing timestamps to be modified.

For any given time value a subtree may be in one of three states: “nascent,” “active,” or “deleted.” A subtree is in the nascent state if it doesn't have a birth timestamp associated with it, or its birth timestamp is later than or equal to the given time value. A subtree is in the active state if its birth timestamp is earlier than the given time value and its death timestamp is later than or equal to the given time value. A subtree is in the deleted state if its death timestamp is earlier than the given time value.

In one set of embodiments, the birth and death timestamps associated with a subtree are stored in one or more data structures that are separate from the subtree. In these embodiments, an index relationship may be maintained between subtree identifiers and birth and death timestamps. which can be used to efficiently identify whether a given subtree is “active” relative to a point in time. Alternatively, the birth and death timestamps associated with a subtree may be stored within the subtree data structure.

In various embodiments, the system includes an update clock that is incremented every time an update is committed. Committing an update includes activating zero or more nascent subtrees and deleting zero or more active subtrees. A nascent subtree is activated by setting the subtree birth timestamp to the current update clock value. An active subtree is deleted by setting the subtree death timestamp to the current update clock value.

During query evaluation, the current value of the update clock is determined at the start of query processing and used for the entire evaluation of the query. Since the clock value remains constant throughout the evaluation of the query, the state of the database remains constant throughout the evaluation of the query, even if updates are being performed concurrently.

When the database manager starts performing a merge, it first saves the current value of the update clock, and uses that value of the update clock for the entire duration of the merge. The stand merge process does not include in the output any subtrees deleted with respect to the saved update clock.

Subtree timestamp updates are allowed during the stand merge operation. To propagate any timestamp updates performed during the merge operation, at the very end of the merge operation the database manager briefly locks out subtree timestamp updates and migrates the subtree timestamp updates from the input stands to the output stand.

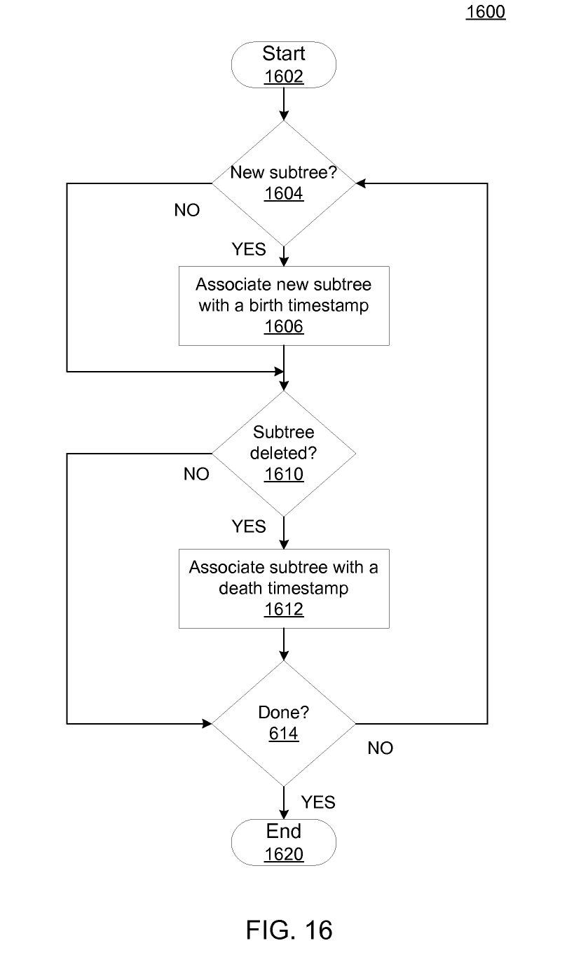

FIG. 16 illustrates the steps performed in associating new subtrees with a birth timestamp and associating deleted subtrees with a death timestamp. According to one set of embodiments, the birth and death timestamps are used to determine the state of the database at a historical point in time. In various embodiments, the flow of FIG. 16 applies whenever a subtree in the database is created or deleted. For example, as described herein, updating a portion of an XML document would cause new updated versions of the affected subtrees to be written to the database and the affected subtrees to be associated with death timestamps. Similarly, deleting a portion of an XML document would cause the affected subtrees to be associated with death timestamps.

If a subtree is being created in the database (1604) (e.g., via an update or insert operation), the new subtree is associated with a birth timestamp indicating the time of creation (1606). The birth timestamp may be unique to the subtree being created, or may be shared among multiple subtrees that are created via a single operation. For example, if a single XML query is executed that creates several subtrees, then the new subtrees may be associated with the same birth timestamp. At step 1610, if a set of subtrees are marked for deletion, deleted subtrees are associated with a death timestamp (1612). At step 1614, if method 1600 is not finished (e.g., an update is still in process) the method returns to step 1610. Using the birth timestamp and death timestamp, queries may be performed for times on or before the current time as will be described below.

### Point-in-Time Query Process

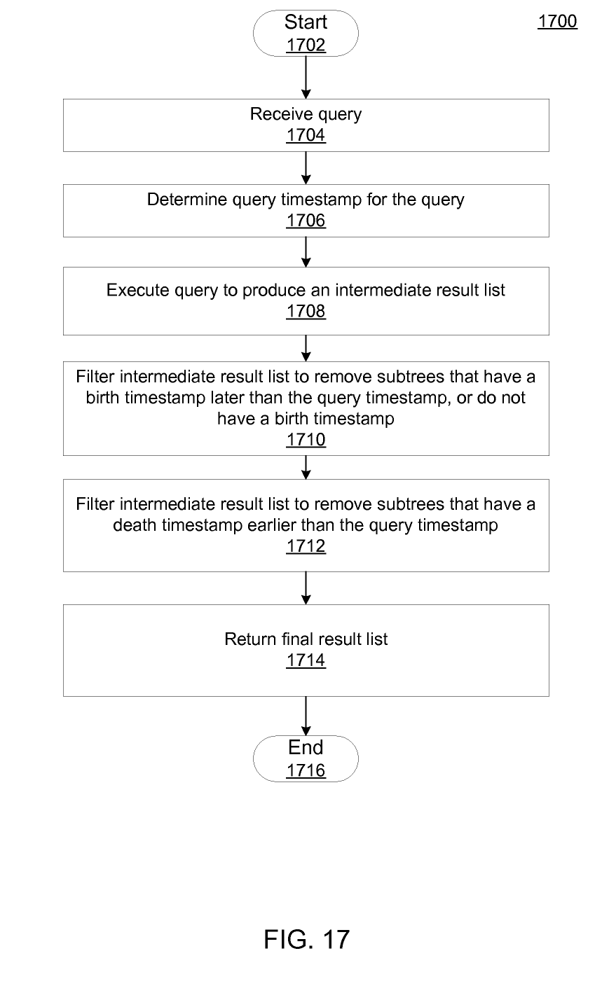

FIG. 17 illustrates the steps performed in processing a point-in-time query in accordance with an embodiment of the present invention. In an exemplary embodiment, method 1700 is executed on query processor 1310 of FIG. 13. Alternatively, method 1700 may be executed on any other component of database system 1300. Further, method 1700 may be implemented in software, hardware, or a combination of the two. One of ordinary skill in the art would recognize may variations, modifications, and alternatives.

At step 1702, a query is received. At step 1704, the query timestamp for the query is determined. In various embodiments, the query timestamp may be embedded within the query itself. In other embodiments, the query timestamp may be determined or read from a separate source. A typical point-in-time query will have a query timestamp that is earlier than the time of query execution (e.g., the “current” time). However, in various embodiments the query timestamp may be equal to the time of query execution. In this manner, “current time” queries may be supported using the same logic as point-in-time (i.e., “historical”) queries.

Once the timestamp for the query has been determined, the query is executed to determine an intermediate result list of subtrees responsive to the query (1708). In one set of embodiments, indexes may be used to provide mappings between terms in the query string of the point-in-time query and the subtrees in the database, independent of timestamps. In these cases, the indexes may be used to determine the intermediate result list. The intermediate result list is then filtered to remove subtrees that are not active at the point in time of the query timestamp. As shown, subtrees in the intermediate result list that have a birth timestamp later than the query timestamp, or subtrees that do not have a birth timestamp (e.g., nascent subtrees) are removed (1710). Further, subtrees in the intermediate result that have a death timestamp earlier than the query timestamp are removed (1712).

In various embodiments, the filtering steps 1710 and 1712 are performed after the indexes described above have been fully resolved and an intermediate result list has been determined at 1708. In other embodiments, the filtering steps may occur concurrently with index resolution during the query execution process (which may be at several different points). At step 1714, the final, filtered result list is returned to the query requestor.

Note that indexes may be changing in real-time underneath the query (because of other queries making changes to the database), but the use of a query timestamp allows the query to “see” a constant view of the database. The query timestamp filters out any changes that have occurred since the start time of query execution (in the case of a “current time” query) or since the point-in-time specified (in the case of a point-in-time query).

It should be appreciated that the specific steps illustrated in FIG. 17 provide a particular method of processing a point-in-time query according to an embodiment of the present invention. Other sequences of steps may also be performed according to alternative embodiments. For example, alternative embodiments of the present invention may perform the steps outlined above in a different order. Moreover, the individual steps illustrated in FIG. 17 may include multiple sub-steps that may be performed in various sequences as appropriate to the individual step. Furthermore, additional steps may be added or removed depending on the particular applications. One of ordinary skill in the art would recognize many variations, modifications, and alternatives.

A database storage reclamation process (e.g., a garbage collection process) may be used to reclaim subtrees having a death timestamp that is dated before selected timestamp (e.g., the oldest-currently-active query in the system). The database storage reclamation process may physically delete subtrees, thereby making the deleted subtrees inaccessible to a query. Therefore, by controlling the timestamps used for a database storage reclamation process, a user may control how far in the past historical database queries may be run.

This detailed description illustrates some embodiments of the invention and variations thereof, but should not be taken as a limitation on the scope of the invention. In this description, structured documents are described, along with their processing, storage and use, with XML being the primary example. However, it should be understood that the invention might find applicability in systems other than XML systems, whether they are later-developed evolutions of XML or entirely different approaches to structuring data. It should also be understood that “XML” is not limited to the current version or versions of XML. An XML file (or XML document) as used herein can be serialized XML or more generally an “infoset.” Generally, XML files are text, but they might be in a highly compressed binary form.

Various features of the present invention may be implemented in software running on one or more general-purpose processors in various computer systems, dedicated special-purpose hardware components, and/or any combination thereof. Computer programs incorporating features of the present invention may be encoded on various computer readable media for storage and/or transmission; suitable media include suitable media include magnetic disk or tape, optical storage media such as compact disk (CD) or DVD (digital versatile disk), flash memory, and carrier signals adapted for transmission via wired, optical, and/or wireless networks including the Internet. Computer readable media encoded with the program code may be packaged with a device or provided separately from other devices (e.g., via Internet download).

Thus, although the invention has been described with respect to specific embodiments, it will be appreciated that the invention is intended to cover all modifications and equivalents within the scope of the following claims.

What is claimed is:

1. A computer-implemented method for processing database queries, the method comprising:
storing a plurality of subtrees in a database, wherein the plurality of subtrees represent one or more structured documents, wherein at least one subtree in the plurality of subtrees has a birth timestamp indicating a time at which the at least one subtree was created in the database, and wherein if a subtree in the plurality of subtrees has been obsoleted, the subtree has a death timestamp indicating a time at which the subtree was obsoleted;
receiving a point-in-time database query comprising a query string and a query timestamp, the query timestamp indicating a historical time for which the query is to apply;
determining an intermediate result list of subtrees responsive to the query string; and
filtering the intermediate result list to generate a final result list of subtrees responsive to the point-in-time database query, the filtering comprising removing subtrees having a birth timestamp later than the query timestamp, and removing subtrees having a death timestamp earlier than the query timestamp.

2. The method of claim 1, wherein the filtering further comprises removing subtrees that do not have a birth timestamp.

3. The method of claim 1, wherein the structured documents are Extensible Markup Language (XML) documents.

4. The method of claim 1, wherein determining the intermediate result list comprises accessing an index that provides a mapping between at least one term in the query string and the plurality of subtrees.

5. The method of claim 1, wherein the point-in-time database query is a read-only query.

6. The method of claim 1, wherein subtrees associated with a death timestamp earlier than a threshold timestamp are periodically deleted from the database.

7. The method of claim 6, wherein the threshold timestamp corresponds to the birth timestamp of the oldest subtree that is not currently associated with a death timestamp.

8. A computer-implemented method for executing a database query against a prior state of a database, the method comprising:
storing a plurality of entries in a database, at least one entry being associated with a time window during which the entry is considered active in the database;
receiving, at a first point in time, a query for the database, the query including a query timestamp indicative of a second point in time prior to the first point in time, the second point in time corresponding to a historical state of the database; and
executing the database query against the historical state of the database, the executing comprising determining entries in the database that were active at the second point in time.

9. A database system comprising:
a database configured to store a plurality of subtrees, wherein the plurality of subtrees represent one or more structured documents, wherein at least one subtree in the plurality of subtrees has a birth timestamp indicating a time at which the at least one subtree was created in the database, and wherein if a subtree in the plurality of subtrees has been obsoleted, the subtree has a death timestamp indicating a time at which the subtree was obsoleted; and
a query engine configured to:
receive a point-in-time database query comprising a query string and a query timestamp, the query timestamp indicating a historical time for which the query is to apply;
determine an intermediate result list of subtrees responsive to the query string; and
filter the intermediate result list to generate a final result list of subtrees responsive to the point-in-time database query, the filtering comprising removing subtrees having a birth timestamp later than the query timestamp, and removing subtrees having a death timestamp earlier than the query timestamp.

10. The system of claim 9, wherein the filtering further comprises removing subtrees that do not have a birth timestamp.

11. A machine-readable medium for a computer system, the machine-readable medium having stored thereon a series of instructions which, when executed by a processing component, cause the processing component to process a database query by:
storing a plurality of subtrees in a database, wherein the plurality of subtrees represent one or more structured documents, wherein at least one subtree in the plurality of subtrees has a birth timestamp indicating a time at which the at least one subtree was created in the database, and wherein if a subtree in the plurality of subtrees has been obsoleted, the subtree has a death timestamp indicating a time at which the subtree was obsoleted;
receiving a point-in-time database query comprising a query string and a query timestamp, the query timestamp indicating a historical time for which the query is to apply;
determining an intermediate result list of subtrees responsive to the query string; and
filtering the intermediate result list to generate a final result list of subtrees responsive to the point-in-time database query, the filtering comprising removing subtrees having a birth timestamp later than the query timestamp, and removing subtrees having a death timestamp earlier than the query timestamp.

12. The machine-readable medium of claim 11, wherein the filtering further comprises removing subtrees that do not have a birth timestamp.
